(19) United States
(12) Patent Application Publication
(10) Pub. No.: US 2022/0259481 A1
(43) Pub. Date: Aug. 18, 2022

(54) ELASTICATOR AND PREPARATION METHOD THEREOF AND CASING EXPANSION LOSS PREVENTION ELASTIC SPACER FLUID FOR CEMENTING

(71) Applicants: SOUTH CHINA UNIVERSITY OF TECHNOLOGY, Guangzhou, Guangdong (CN); GUANGZHOU WUSHAN MATERIAL TECHNOLOGY CO., LTD, Guangzhou, Guangdong (CN)

(72) Inventors: Jiangxiong WEI, Guangdong (CN); Jianglin ZHU, Guangdong (CN); Yuwei LUO, Guangdong (CN); Donghui LUO, Guangdong (CN); Zhandong LI, Guangdong (CN); Huan CAO, Guangdong (CN); Haoliang HUANG, Guangdong (CN); Yuchang HE, Guangdong (CN)

(21) Appl. No.: 17/289,746

(22) PCT Filed: Oct. 21, 2020
(86) PCT No.: PCT/CN2020/122387

§ 371 Date: Apr. 29, 2021

(30) Foreign Application Priority Data
Oct. 12, 2019 (CN) 201910968950.6

(51) Int. Cl. C09K 8/42

(52) U.S. Cl. CPC C09K 8/424

(57) ABSTRACT

An elasticator and a preparation method thereof and a casing expansion loss prevention elastic spacer fluid for cementing are provided. The preparation method of the elasticator includes the following steps of: (1) taking polycaprolactone and an inorganic porous material for fully mixing under a heating condition to obtain a mixture; and (2) mixing the mixture with a high-elastic modulus rubber powder to obtain an elasticator.

### TECHNICAL FIELD

The disclosure relates to the field of oil field well-drilling and well-cementing, in particular to an elasticator and a preparation method thereof and a casing expansion loss prevention elastic spacer fluid for cementing.

### BACKGROUND

When an offshore semi-submersible platform is in 13⅜″ casing and 9⅝″ casing cementing operations, cementing slurry generally does not return to the seabed, and there will be hundreds of meters or even thousands of meters of fluid which is from the top of the slurry sealed between 13⅜″ casing and 20″ casing , or between 13⅜″ casing and 9⅝″ casing; and the fluid in this section is namely the spacer fluid which mainly isolates the drilling fluid from the cementing slurry, thus preventing the drilling fluid from polluting the cementing slurry for cementing.

For an ultra-temperature producing well or deep-water offshore drilling, the temperature at the bottom of the well differs greatly from that at the well head. For example, for a 2000 m-depth deep well, if the vertical drilling depth is 3000 m, the underground temperature gradient is 4° C./100 m, the bottom hole temperature is 120° C.-130° C., and the temperature at the seabed of the surface casing is close to 0° C., and the spacer liquid system blocked within the two layers of casings is very likely to suddenly swell under heating conditions; thereby when the expansion loss on the casing exceeds the squeezing force of the casing itself, it influences the quality of cementing and production cycle of the entire well. Similarly, it is also faced with the same problem of cementing in the high temperature/ultra-temperature well.

Conventional spacer fluid at home is mainly prepared by adding a fluid loss agent and water to a separant, and has the major disadvantages below: related data and experimental results show that (PERIODICALS OF PETROLEUM DRILLING TECHNIQUES, Influences of Temperature and Pressure on Borehole Fluid Density), in a closed environment, the expansion pressure of a conventional spacer fluid improves 3-8 MPa, while the collapsing strength of the 13⅜″ casing is only 20 MPa around when the temperature rises 10° C. every time.

### SUMMARY

### Technical Problem

### Solution to the Problem

### Technical Solution

To solve the problem and shortcomings in the prior art, an objective of the disclosure is to provide an elasticator and a preparation method thereof and a casing expansion loss prevention elastic spacer fluid for cementing.

The objective of the disclosure is achieved by at least one of the following technical solutions:

The disclosure provides a preparation method of an elasticator, includes the following steps of:

(1) taking polycaprolactone and an inorganic porous material for fully mixing under a heating condition to obtain a mixture;

(2) mixing the mixture with a rubber powder to obtain an elasticator.

Preferably, a heating temperature in step (1) is 60-90° C.; the inorganic porous material is in micron-grade; the inorganic porous material includes one or more of porous ceramisite, diatomite, zeolite or porous glass; a mass ratio of the polycaprolactone to the inorganic porous material is 1:(1-8).

Preferably, a mass ratio of the mixture to the rubber powder in step (2) is (1-3):1; and a temperature during mixing is from room temperature to 53° C.

Preferably, the rubber powder in step (2) is a high-elastic modulus rubber powder having an elasticity modulus of 0.01-1 Gpa.

Preferably, the mixing in steps (1) and (2) refers to stirring for mixing, stirring rate in step (1) is 100-150 rpm and stirring time is greater than 3 hours; stirring rate in step (2) is 30-120 rpm and stirring time is greater than 1 hour.

Preferably, polycaprolactone and inorganic porous material in step (1) are placed in water after fully mixing, and then stirred for 5-10 minutes under a condition of 30-50 RPM, followed by standing for 30 minutes above to obtain a float, thus obtaining the mixture.

The disclosure further provides an elasticator prepared by the preparation method above.

The disclosure further provides a casing expansion loss prevention elastic spacer fluid for cementing, including the following components: water, a defoamer, a separant, and an elasticator; and a mass ratio of the water, the defoamer, the separant, to the elasticator is 100:(0.5-1):(0.5-3):(30-60); where the elasticator is the above-mentioned elasticator.

Preferably, the defoamer is PC-X60L reagent.

Preferably, the separant is PC-S23S.

### BENEFICIAL EFFECTS OF THE INVENTION

### Beneficial Effect

Compared with the prior art, the disclosure has the following beneficial effects and advantages:

(1) the elasticator provided by the disclosure can be compressed and deformed to release space under a certain pressure environment, and meanwhile can rebound timely to recover its deformation when pressure drops, thus effectively adjusting the pressure of an entrapment liquid; the elasticator can effectively reduce the thermal-expansion internal pressure of a fluid in the premise of free from breaking and chemical reaction in advance;

(2) the disclosure also provides an elastic spacer fluid containing the elasticator; the spacer fluid has good rheological property and dehydration property, and good compatibility to cementing slurry and mud; and the elasticator is made of an inert material, thus not influencing other performances of the spacer fluid; moreover, the elastic spacer fluid system has good extension property, and can release the pressure produced by own thermal expansion better.

### EMBODIMENTS OF THE INVENTION

### Detailed Description

Detailed embodiments of the disclosure will be further described in detail in combination with the specific examples below; and embodiments of the disclosure are not limited thereto.

### EXAMPLES

The example provides a preparation method of an elasticator, including the following steps:

(1) 1000 g polycaprolactone and 2000 g micron-grade porous ceramics were taken and stirred at a temperature of 70° C. for mixing for 3.5 hours to obtain a mixture, where the stirring rate was 120 rpm;

(2) 2000 g mixture and 1000 g nitrile rubber powder were stirred at a temperature of 30° C. for mixing for 1.5 hour to obtain an elasticator; where the stirring rate was 60 rpm;

The example further provides a casing expansion loss prevention elastic spacer fluid for cementing; including the following parts by weight of components:

400 g water, 2 g defoamer PC-X60L reagent, 10 g separant PC-S32S and 180 g of the elasticator.

The example further provides a blank base spacer fluid, including the following parts by weight of components: 400 g water, 2 g defoamer PC-X60L agent, 10 g separant PC-S32S.

A test method on the pressure of fresh water, blank base spacer fluid and elastic spacer fluid under heating up conditions was as follows:

(1) Test on the pressure of fresh water under heating up conditions

A high-temperature and high-pressure reaction vessel was filled with fresh water at a room temperature of 26° C.; the fresh water was applied an initial pressure of 2856.5 psi (19.7 MPa), then heated up according to the heating temperature procedure set by UCA to observe the growth trend of the pressure till temperature raised to 90° C.; and temperature and pressure were read, and an increment of the pressure in each temperature zone was recorded.

(2) Test on the pressure of a blank base spacer fluid and an elastic spacer fluid under heating up conditions

Firstly, the spacer fluid was placed at an environment of a pressurized thickening apparatus to simulate shaft bottom environment for 20 minutes to increase the bottom hole circulating temperature (BHCT) to 55° C., keeping for 30 minutes at an environment of 40 MPa around; then the spacer fluid was cooled to a room temperature of 26° C., and heated up according to a heating temperature procedure set by UCA to 90° C.; and temperature and pressure were read when the temperature increased 5° C. every time.

In comparison to the pressure of fresh water and blank base spacer fluid during heating-up process, the pressure in the same temperature zone was observed to judge whether the elastic spacer fluid could relieve the pressure growth. If the pressure of the elastic spacer fluid was obviously lower than that of fresh water in the same temperature zone, it indicates that the spacer fluid had a good capacity of relieving pressure growth.

The tested pressure of fresh water, blank base spacer fluid and elastic spacer fluid under heating up conditions was shown in Table 1, Table, 2 and Table 3:

TABLE 1
Pressure of fresh water with the increase of temperature

| Temperature (° C.) | Pressure (psi) |
|---|---|
| 26 | 2856.50 (19.7 MPa) |
| 30 | 3161.00 (21.80 MPa) |
| 35 | 3628.32 (25.02 MPa) |
| 40 | 4200.63 (28.97 MPa) |
| 45 | 4697.07 (32.39 MPa) |
| 50 | 5397.07 (37.22 MPa) |
| 55 | 6037.25 (41.64 MPa) |
| 60 | 6722.09 (46.36 MPa) |
| 65 | 7461.59 (51.46 MPa) |
| 70 | 8292.17 (57.18 MPa) |
| 75 | 8952.44 (61.74 MPa) |
| 80 | 9823.07 (67.75 MPa) |
| 85 | 10721.88 (73.94 MPa) |
| 90 | 11292.42 (77.88 MPa) |

A high-temperature and high-pressure reaction vessel was filled with fresh water; where the temperature was circulated at room temperature of 26° C., and the pressure was subjected to the initial pressure 20 MPa of the spacer fluid at 1500 m depth around; then heated up according to a preset heating temperature procedure to observe the growth trend of the pressure curve till temperature raised to 90° C.; and temperature and pressure curves were read after the temperature zone was smooth, and an increment of the pressure in each temperature zone was recorded.

TABLE 2
Pressure of the blank base spacer fluid
with the increase of temperature

| Temperature (° C.) | Pressure (psi) |
|---|---|
| 26 | 2856.50 (19.7 MPa) |
| 30 | 3101.00 (21.38 MPa) |
| 35 | 3508.42 (24.19 MPa) |
| 40 | 4006.63 (27.63 MPa) |
| 45 | 4477.07 (30.87 MPa) |
| 50 | 5087.02 (35.08 MPa) |
| 55 | 5846.02 (40.31 MPa) |
| 60 | 6492.09 (44.77 MPa) |
| 65 | 7161.32 (49.39 MPa) |
| 70 | 7984.17 (55.06 MPa) |
| 75 | 8452.32 (58.29 MPa) |
| 80 | 9226.45 (63.63 MPa) |
| 85 | 10432.27 (71.94 MPa) |
| 90 | 10845.24 (74.79 MPa) |

TABLE 3
Pressure of the elastic spacer fluid with the increase of temperature

| Temperature (° C.) | Pressure (psi) |
|---|---|
| 26 | 2856.50 (19.7 MPa) |
| 30 | 2900.00 (20.00 MPa) |
| 35 | 3045.00 (21.00 MPa) |
| 40 | 3235.00 (22.43 MPa) |
| 45 | 3602.00 (24.84 MPa) |
| 50 | 4108.00 (28.33 MPa) |
| 55 | 4565.50 (31.48 MPa) |
| 60 | 4907.00 (33.84 MPa) |
| 65 | 5081.00 (35.04 MPa) |
| 70 | 5422.50 (37.39 MPa) |
| 75 | 5412.00 (37.32 MPa) |
| 80 | 5412.00 (37.32 MPa) |
| 85 | 5531.00 (38.14 MPa) |
| 90 | 5531.00 (38.14 MPa) |

Firstly, the elastic spacer fluid was placed at an environment of a pressurized thickening apparatus to simulate shaft bottom situation for 20 minutes to increase BHCT to 55° C., keeping for 30 minutes at an environment of 40 MPa around; then the elastic spacer fluid was cooled to a room temperature of 26° C., and re-heated according to a heating temperature procedure to 78° C. (bottom hole standing temperature, BHST) up to 90° C. to the maximum. A temperature pressure curve was read every increasing 5° C. Heating rate: 2.5° C./min. In comparison to the pressure curve of fresh water and blank base spacer fluid during heating-up process, the pressure in the same temperature zone was observed to judge whether the elastic spacer fluid could relieve the pressure growth. The pressure of the elastic spacer fluid was obviously lower than that of fresh water and blank base spacer fluid under the same temperature zone, indicating that the elastic spacer fluid had a good capacity of relieving pressure growth.

By the comparison of the above three groups of data, it can be seen that the pressure of water has a maximum change with the change of the temperature, being up to 11292.42 psi (77.88MPa) at 90° C.; the pressure of the blank base spacer fluid has a relatively obvious change with the change of the temperature, being up to 10845.24 psi (74.79 MPa) at 90° C.; the pressure of the elastic spacer fluid has a rather obvious trend of decline with the change of the temperature; the pressure is 4907.00 psi (33.84 MPa) at 60° C.; the pressure is kept 5412.00 psi (37.32 MPa) within a temperature range from 70° C. to 80° C.; the pressure is only 5531.00 (38.14 MPa) at 90° C.; compared with water, the pressure decreases by 5761.42 psi (39.73 MPa), which indicates that the elastic spacer fluid has a good effect of releasing pressure.

The obtained elastic spacer fluid was subjected to density and funnel viscosity tests. Results show that the elastic spacer fluid has a funnel viscosity of 100 S, no obvious sedimentation at 12 hours and has virtual sedimentation at 24 hours.

Cementing slurry was prepared and thickening compatibility of the elastic spacer fluid with the cementing slurry was tested; and the blank cementing slurry included the following parts by weight of components: 40.6 g water, 0.5 g PC-X62L, 1 g PC-F41L, 3 g PC-G86L, 4 g PC-GS12L, 0.25 g PC-H21L, 1.5 g PC-B10 and 100 g JH/G. The above spacer fluid was added to the prepared blank cementing slurry so that the parts by volume of the spacer fluid polluting the cementing slurry was 25%, thus obtaining the cementing slurry polluted by the elastic spacer fluid. The thickening time of the blank cementing slurry and the cementing slurry polluted by the elastic spacer fluid was respectively 195 minutes and 228 minutes; the experiment results indicate that under the conditions of simulating bottom hole temperature and pressure, the bottom hole cementing slurry was polluted by 25% parts by volume of the elastic spacer fluid, thickening time of the cementing slurry extended 34 minutes, resulting no phenomenon of shortening the thickening or exceeding/extending the thickening period.

As an intermediate fluid to isolate cementing slurry from mud, the elastic spacer fluid will indispensably contact with and pollute these two fluids during the process of replacing pumping; it is rather important whether the rheological property, thickening time, squeezing force and other performances of the cementing slurry are influenced after pollution; and the pollution to mud is reflected in whether the rheological property is up to the requirements.

The cementing slurry polluted by different content of the elastic spacer fluid was subjected to a rheological compatibility test with a six-rate rotational viscometer; before testing, the cementing slurry polluted by the elastic spacer fluid was conserved for 20 minutes at a temperature of 46° C. Test results were shown in Table 4.

TABLE 4
Test results of the compatibility of the spacer
fluid to the blank cementing slurry

| Blank cementing | Spacer | | | | | | |
|---|---|---|---|---|---|---|---|
| slurry | fluid | | | | | | |
| Volume | Volume | Rheological reading | | | | | |
| % | % | 600 | 300 | 200 | 100 | 6 | 3 |
| 100 | 0 | — | 155 | 116 | 75 | 22 | 15 |
| 95 | 5 | 270 | 165 | 120 | 79 | 32 | 22 |
| | | | 165 | 121 | 75 | 17 | 13 |
| 75 | 25 | 265 | 170 | 120 | 75 | 13 | 8 |
| | | | 160 | 115 | 67 | 9 | 7 |
| 50 | 50 | 245 | 151 | 115 | 80 | 25 | 19 |
| | | | 152 | 110 | 70 | 15 | 12 |
| 25 | 75 | 156 | 98 | 80 | 54 | 16 | 13 |
| | | | 97 | 73 | 46 | 15 | 13 |
| 5 | 95 | 111 | 86 | 65 | 45 | 14 | 11 |
| | | | 80 | 63 | 43 | 12 | 9 |
| 0 | 100 | 112 | 82 | 70 | 51 | 13 | 10 |

On-site water-base mud from CNOOC Zhanjiang Branch Lingshui 17-2 Gas Field was taken and mixed with different amount of the elastic spacer fluid; and the results of compatibility of the elastic spacer fluid to the on-site water-base mud were shown in Table 5.

TABLE 5
Results of compatibility of the elastic spacer
fluid to the on-site water-base mud

| | Spacer | | | | | | |
|---|---|---|---|---|---|---|---|
| Mud | fluid | | | | | | |
| Volume | Volume | Rheological reading | | | | | |
| % | % | 600 | 300 | 200 | 100 | 6 | 3 |
| 100 | 0 | — | 35 | 27 | 16 | 5 | 4 |
| 95 | 5 | 68 | 42 | 30 | 18 | 5 | 4 |
| | | | 40 | 28 | 17 | 5 | 4 |
| 75 | 25 | 106 | 63 | 45 | 28 | 7 | 5 |
| | | | 63 | 47 | 28 | 6 | 5 |
| 50 | 50 | 140 | 85 | 71 | 45 | 13 | 10 |
| | | | 86 | 74 | 45 | 10 | 8 |
| 25 | 75 | 75 | 46 | 40 | 30 | 8 | 7 |
| | | | 48 | 40 | 26 | 6 | 5 |
| 5 | 95 | 96 | 66 | 55 | 42 | 12 | 10 |
| | | | 65 | 50 | 34 | 8 | 7 |
| 0 | 100 | 112 | 82 | 70 | 51 | 13 | 10 |

Experiment results of Tables 4 and 5 show that the spacer fluid has a minor impact on the rheological property after contacting the blank cementing slurry and the on-site water-base mud; and its replacement to cementing slurry and rheological property satisfy the construction requirements.

After the spacer fluid was added to cementing slurry, the squeezing force of the cementing slurry declined usually; based on enterprise's standard requirements, the decline in squeezing force is less than 70%. In this example, the influence of the elastic spacer fluid on the squeezing force of cementing slurry was tested. Test results indicate that the blank cementing slurry has a squeezing force (24 h, 71° C.) of 29.7 Mpa; the cementing slurry polluted by the elastic spacer fluid (the elastic spacer fluid has a volume fraction of 25%) has a squeezing force (24 h, 71° C.) of 15.3 Mpa, and the squeezing force declines 48%, which satisfies the enterprise's standard requirements.

Thus, it can be seen that the elastic spacer fluid provided by the disclosure has a good effect of pressure release. The elastic spacer fluid system has good rheological compatibility to the on-site water-base mud and good sedimentation stability. The elastic spacer fluid system has good rheological compatibility to cementing slurry, almost no thickening influence, slight decline of squeezing force, and is up to enterprise's standard requirements.

The above are only preferred embodiments of the disclosure and are not intended to limit the disclosure in any form. Any equivalent variation, modification or evolution to the above examples made by a person skilled in the art based on the technical solution of the disclosure falls within the scope of the technical solution of the disclosure.

1. A preparation method of an elasticator, comprising the following steps of:
(1) taking polycaprolactone and an inorganic porous material for fully mixing under a heating condition to obtain a mixture; and
(2) mixing the mixture with a rubber powder to obtain an elasticator.

2. The preparation method of the elasticator according to claim 1, wherein
a heating temperature in step (1) is 60-90° C.,
the inorganic porous material is in micron-grade,
the inorganic porous material comprises one or more of porous ceramisite, diatomite, zeolite or porous glass,
a mass ratio of the polycaprolactone to the inorganic porous material is 1:(1-8).

3. The preparation method of an elasticator according to claim 1, wherein
a mass ratio of the mixture to the rubber powder in step (2) is (1-3):1,
a temperature during mixing is from room temperature to 53° C.

4. The preparation method of an elasticator according to claim 1, wherein the rubber powder in step (2) is a high-elastic modulus rubber powder having an elasticity modulus of 0.01-1 Gpa.

5. The preparation method of an elasticator according to claim 1, wherein
the mixing in steps (1) and (2) refers to stirring for mixing,
in step (1), a stirring rate is 100-150 rpm and a stirring time is greater than 3 hours,
in step (2), a stirring rate is 30-120 rpm and a stirring time is greater than 1 h.

6. The preparation method of an elasticator according to claim 1, wherein the polycaprolactone and the inorganic porous material in step (1) are placed in water after fully mixing, and then stirred for 5-10 minutes under a condition of 30-50 RPM, followed by standing for 30 minutes above to obtain a float, thus obtaining the mixture.

7. An elasticator prepared by the preparation method according to claim 1.

8. A casing expansion loss prevention elastic spacer fluid for cementing, comprising the following components:
water;
a defoamer;
a separant; and
an elasticator,
wherein a mass ratio of the water, the defoamer, the separant, and the elasticator is 100:(0.5-1) :(0.5-3):(30-60),
wherein the elasticator is the elasticator of claim 6.

9. The casing expansion loss prevention elastic spacer fluid for cementing according to claim 8, wherein the defoamer is PC-X60L reagent.

10. The casing expansion loss prevention elastic spacer fluid for cementing according to claim 8, wherein the separant is PC-S23S.

11. An elasticator prepared by the preparation method according to claim 2.

12. An elasticator prepared by the preparation method according to claim 3.

13. An elasticator prepared by the preparation method according to claim 4.

14. An elasticator prepared by the preparation method according to claim 5.

15. An elasticator prepared by the preparation method according to claim 6.
